(19) United States
(12) Patent Application Publication
(10) Pub. No.: US 2026/0091743 A1
(43) Pub. Date: Apr. 2, 2026

(54) IN-VEHICLE DEVICE, SERVICE PROVIDING METHOD, AND SERVICE PROVIDING PROGRAM

(71) Applicant: DENSO CORPORATION, Kariya-city (JP)

(72) Inventors: Ataro YAMADA, Kariya-city (JP); Seiji Murata, Kariya-city (JP); Hideyuki Yamaguchi, Kariya-city (JP); Yasuaki Kurita, Kariya-city (JP)

(21) Appl. No.: 19/414,061

(22) Filed: Dec. 9, 2025

Related U.S. Application Data
(63) Continuation of application No. PCT/JP2024/020896, filed on Jun. 7, 2024.

(30) Foreign Application Priority Data
Jun. 14, 2023 (JP) 2023-097691

(51) Int. Cl. B60R 16/023; G07C 5/02; G07C 5/08; H04L 67/125

(52) U.S. Cl. CPC B60R 16/0231; G07C 5/02; G07C 5/0816; H04L 67/125

(57) ABSTRACT

An in-vehicle device mounted on a vehicle is provided that includes a cooperation controller configured to provide cooperation between a service application configured to provide a service to the vehicle and a control system function block configured to control the vehicle. The control system function block includes a function interface configured to convert an access request expressed in a vehicle-independent format into a vehicle-dependent format. The cooperation controller is configured to forward the access request to the control system function block. The cooperation controller is configured to determine whether or not a use suspension condition is satisfied and switch over operation of the vehicle control system based on function interface information, vehicle state information and user input information.

### CROSS REFERENCE TO RELATED APPLICATIONS

This application is a continuation application of International Patent Application No. PCT/JP2024/020896 filed on Jun. 7, 2024, which designated the U.S. and claims the benefit of priority from Japanese Patent Application No. 2023-097691 filed in the Japan Patent Office on Jun. 14, 2023. The entire disclosures of all of the above applications are incorporated herein by reference.

### TECHNICAL FIELD

The present disclosure relates to an in-vehicle device that provides a service to a vehicle, a service providing method, and a service providing program stored on a non-transitory storage medium.

### BACKGROUND

A vehicle is used to provide a service. The inventors'study has revealed that suspending such use may cause disadvantage in some cases.

### SUMMARY

According to one aspect of the present disclosure, an in-vehicle device mounted on a vehicle and connected to a plurality of electronic control units in a vehicle control system comprises a cooperation controller configured to provide cooperation between a service application configured to provide a service to the vehicle and a control system function block configured to control the vehicle. The control system function block includes a function interface configured to convert an access request expressed in a vehicle-independent format into a vehicle-dependent format. The cooperation controller is configured to forward the access request to the control system function block. The cooperation controller is configured to determine whether or not a use suspension condition is satisfied and switch over operation of the vehicle control system based on function interface information, vehicle state information and user input information.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a service providing system;

FIG. 2 is a block diagram illustrating a configuration of an ECU;

FIG. 3 is a block diagram illustrating a charging procedure;

FIG. 4 is diagram illustrating an API contracting procedure;

FIG. 5 is a block diagram illustrating a destination of a first API use suspension request;

FIG. 6 is a block diagram illustrating a destination of a second API use suspension request;

FIG. 7 is a flowchart illustrating the first half of an API use control process; and

FIG. 8 is a flowchart illustrating the latter half of the API use control process.

### DETAILED DESCRIPTION

There is a technology where a vehicle includes: a controller that operates the vehicle based on operation information received from a management server; a management section that manages a compartment of the vehicle where a service user receives a service from a service provider; and an interface section that is set in association with service-related information provided by the service provider and the compartment.

When a service provider provides a service to a vehicle, it may be necessary to acquire, from a service provision target vehicle, vehicle information on the vehicle or to cause the target vehicle to perform a given operation or process.

When the service provider utilizes the vehicle by acquiring the vehicle information from the vehicle or by causing the vehicle to perform the given action or process, it may be desirable that the service provider should be charged for this utilization.

A detailed study by the inventors has revealed such an issue that when the above utilization by the service provider is uniformly suspended in cases where a charging-related factor (e.g., use fee exceeds an upper limit) requires to suspend the above utilization, this may impair convenience of the user using the service provided by the service provider.

The present disclosure improves service user convenience.

One aspect of the present disclosure is an in-vehicle device mounted a vehicle and connected to a plurality of electronic control units by an in-vehicle network, wherein the in-vehicle device and the plurality of electronic control units are included in a vehicle control system.

The in-vehicle device of the present disclosure comprises a cooperation controller configured to provide cooperation between a service application configured to provide a service to the vehicle and a control system function block configured to control the vehicle. The control system function block includes a function interface configured to convert an access request expressed in a vehicle-independent format and transmitted from the service applications into a vehicle-dependent format. The cooperation controller is configured to forward the access request, transmitted from the service application, to the control system function block.

The cooperation controller includes a use suspension determiner and a use controller.

The use suspension determiner is configured to determine whether or not a use suspension condition, which is preset and indicates that use of the function interface is required to be suspended by a factor related to charging for use of at least one of the service application or the function interface, is satisfied.

The use controller is configured to switch over operation of the vehicle control system based on: function interface information relating to the function interface for which the use suspension condition is satisfied; vehicle state information indicating a vehicle state; and user input information entered by a user who uses the vehicle.

The in-vehicle device of the present disclosure configured above switches over the operation of the vehicle control system based on the function interface information and the vehicle state information and the user input information. Because of this, the in-vehicle device of the present disclosure can suppress occurrence of a situation in which the use of the function interface is uniformly suspended when use of the function interface is required to be suspended by a factor related to charging and as a result the user becomes unable to use the service, improving convenience of the user using the service.

Another aspect of the present disclosure is a service providing method performed by an in-vehicle device mounted on a vehicle and connected to a plurality of electronic control units by an in-vehicle network, wherein the in-vehicle device and the plurality of electronic control units are included in a vehicle control system.

The in-vehicle device includes a cooperation controller configured to provide cooperation between a service application and a control system function block. The control system function block includes a function interfaces. The cooperation controller is configured to forward an access request, transmitted from the service application, to the control system function block.

In the service providing method of the present disclosure, the cooperation controller determines whether or not a use suspension condition, which is preset and indicates that use of the function interface is required to be suspended by a factor related to charging for use of at least one of the service application or the function interface, is satisfied. The use controller is configured to switch over operation of the vehicle control system based on: function interface information relating to the function interface for which the use suspension condition is satisfied; vehicle state information indicating a vehicle state; and user input information entered by a user who uses the vehicle.

The service providing method of the present disclosure is a method performed by the in-vehicle device of the present disclosure, and executing the method provides the same effect as the in-vehicle device of the present disclosure.

Yet another aspect of the present disclosure is a service providing program that causes a computer of an in-vehicle device to function as a function interface, a cooperation controller, a use suspension determiner and a controller, wherein the in-vehicle device is mounted on a vehicle and connected to a plurality of electronic control units by an in-vehicle network, wherein the in-vehicle device and the plurality of electronic control units are included in a vehicle control system.

A computer controlled by the service providing program of the present disclosure can constitute a part of the in-vehicle device of the present disclosure, and can provide the same effect as the in-vehicle device of the present disclosure.

Hereinafter, embodiments of the present disclosure will be described with reference to the drawings.

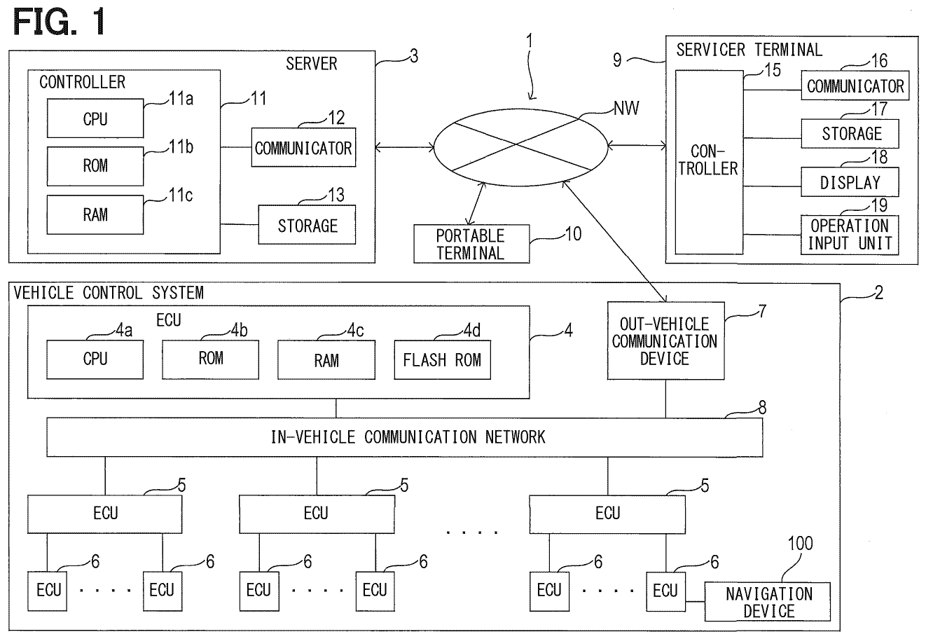

As illustrated in FIG. 1, a service providing system 1 of the present embodiment includes a vehicle control system 2 and a server 3.

The vehicle control system 2 is mounted on a vehicle and has a function of performing data communication with the server 3 via a wide-area wireless communication network NW.

The server 3 has a function of performing data communication with the vehicle control system 2 via the wide-area wireless communication network NW. In the server 3, an application store accessible via the wide-area wireless communication network NW or the Internet is installed.

The vehicle mounted with the vehicle control system 2 may have an automated driving function in addition to a manual driving function. The vehicle may be a hybrid vehicle with an engine and an electric motor as the drive source for travel. The vehicle is not limited to a vehicle with an automated driving function and a hybrid vehicle, and may be a vehicle with only a manual driving function, or may be a vehicle with only an engine or only an electric motor as the drive source for travel. Hereinafter, the vehicle mounted with the vehicle control system 2 is simply referred to as the vehicle.

The vehicle control system 2 includes a single ECU 4, a plurality of ECUs 5, a plurality of ECUs 6, a vehicle-outside communication device 7, and an in-vehicle communication network 8. The ECU is an abbreviation for electronic control unit.

The ECU 4 controls the plurality of ECUs 5 to provide cooperated control of the entire vehicle.

The ECU 5 is provided for each domain, and the ECU 5 provided for a respective domain mainly controls ECUs 6 existing within that domain, where domains are those into which the vehicle is divided on a function basis. A respective ECU 5 is connected to the ECUs 6, which are subordinate of this respective ECU 5, via an individually provided lower layer network (for example, CAN). CAN is an abbreviation for Controller Area Network. CAN is a registered trademark. The domains include, for example, powertrain, body, chassis, cockpit, etc.

The ECUs 6 connected to the ECU 5 belonging to the power train domain include, for example, an ECU 6 for controlling an engine, an ECU 6 for controlling a motor, an ECU 6 for controlling a battery, and the like.

The ECUs 6 connected to ECU 5 belonging to the body domain include, for example, an ECU 6 for controlling an air conditioner, an ECU 6 for controlling a door, and the like.

The ECUs 6 connected to the ECU 5 belonging to the chassis domain include, for example, an ECU 6 for controlling braking, an ECU 6 for controlling steering, and the like.

The ECUs 6 connected to the ECU 5 belonging to the cockpit domain include, for example, an ECU 6 for controlling display of a meter and a navigation device 100, an ECU 6 for controlling an input device operated by an occupant of the vehicle, and the like.

The vehicle-outside communication device 7 performs data communication with the server 3 via the wide-area wireless communication network NW.

The in-vehicle communication network 8 includes CAN FD and Ethernet. Ethernet is a registered trademark. CAN FD is an abbreviation for CAN with Flexible Data Rate. CAN FD connects the ECU 4 to each ECU 5 and the vehicle-outside communication device 7 via a bus. Ethernet individually connects between the ECU 4 and a respective ECU 5 and between the ECU 4 and the vehicle-outside communication device 7.

The ECU 4 includes, as its main component, a microcomputer including a CPU 4a, a ROM 4b, a RAM 4c, and the like. Various functions of the microcomputer are implemented by the CPU 4a executing a program stored in a non-transitory tangible storage medium. In this example, the ROM 4b corresponds to the non-transitory tangible storage medium storing the program. Execution of the program causes execution of the method corresponding to the program. Pat or all of the functions executed by the CPU 4a may be configured as hardware by one or more ICs or the like. Further, the number of microcomputers included in the ECU 4 may be one or more.

The ECU 4 further includes a flash ROM 4d. The flash ROM 4d is a rewritable non-volatile memory.

Each of the ECU 5, the ECU 6, and the vehicle-outside communication device 7 is an electronic control unit including, as its main component, a microcomputer including a CPU, ROM, RAM, and the like, similarly to the ECU 4. Further, the number of microcomputers included in each of the ECU 5, the ECU 6, and the vehicle-outside communication device 7 may be one or more. The ECU 5 supervises one or more ECUs 6. The ECU 4 supervises one or more ECUs 5 or supervises the ECUs 5, 6 and the vehicle-outside communication device 7 of the entire vehicle.

Hereinafter, unless otherwise specified, the ECU 4, ECU 5, ECU 6, and the vehicle-outside communication device 7 will be collectively referred to as in-vehicle devices 4 to 7.

The server 3 includes a controller 11, a communicator 12, and a storage 13.

The controller 11 includes, as its main component, a microcomputer including a CPU 11a, a ROM 11b, a RAM 11c, and the like. Various functions of the microcomputer are implemented by the CPU 11a executing a program stored in a non-transitory tangible storage medium. In this example, the ROM 11b corresponds to the non-transitory tangible storage medium storing the program. Execution of the program causes execution of the method corresponding to the program. Part or all of the functions executed by the CPU 11a may be configured as hardware by one or more ICs or the like. The number of microcomputers included in the controller 11 may be one or more.

The communicator 12 performs data communication with the vehicle control system 2 via the wide-area wireless communication network NW. The storage 13 is a storage device for storing various data.

The service providing system 1 further includes a servicer terminal device 9. The servicer terminal device 9 is a device managed by the service provider SV (hereinafter referred to as “servicer SV”) described later, and is a personal computer, for example.

The servicer terminal device 9 includes a controller 15, a communicator 16, a storage 17, a display 18, and an operation input unit 19.

The controller 15 includes, as its main component, a microcomputer including a CPU, a ROM, a RAM, and the like.

The communicator 16 performs data communication with the vehicle control system 2 and the server 3 via the wide-area wireless communication network NW. The storage 17 is a storage device for storing various data. The display 18 includes a display device not shown in the drawings, and displays various images on a display screen of the display device. The operation input device 19 outputs input operation information to specify an input operation performed by a user via a keyboard and a mouse not shown in the drawings.

The service providing system 1 further includes a portable terminal device 10. The portable terminal device 10 is an information processing terminal (e.g., smartphone or the tablet) carried by a driver of the vehicle (i.e., user US, described later). The portable terminal device 10 has a function of performing data communication with the vehicle control system 2 via the wide-area wireless communication network NW.

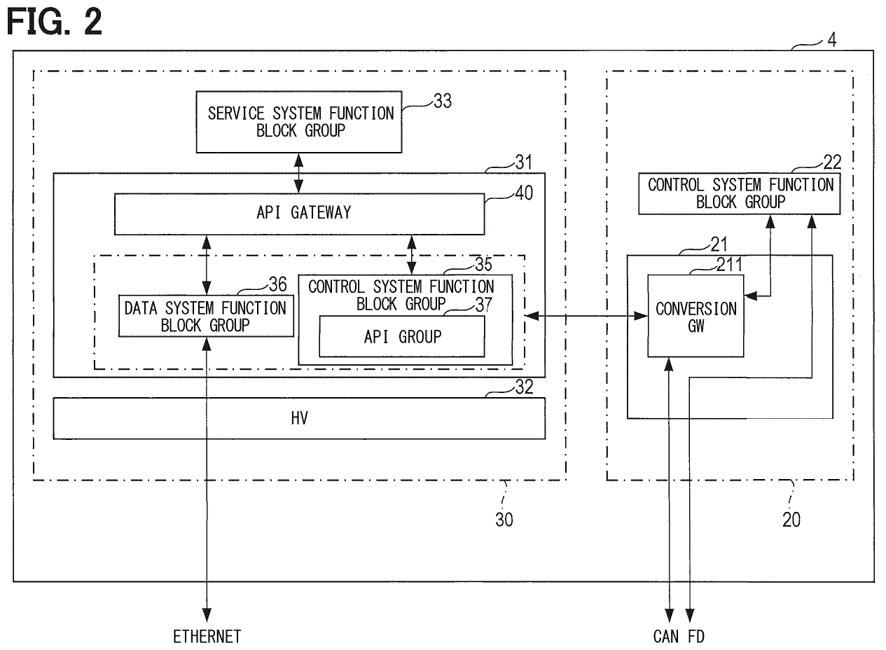

As illustrated in FIG. 2, the ECU 4 includes a real-time processing unit 20 and an application processing unit 30 (hereinafter, app processing unit 30). When the ECU 4 includes multiple CPUs 4a, the real-time processing unit 20 and the application processing unit 30 may be implemented by processes executed by the same CPU or by processes executed by separate CPUs.

The real-time processing unit 20 cooperates with in-vehicle devices 5 to 7 connected via CAN FD to perform vehicle control and the like that require real-time performance. The application processing unit 30 cooperates with the in-vehicle devices 5 to 7 connected via the Ethernet to execute various applications (e.g., an entertainment application, etc.) that require high processing capability.

The application processing unit 30 has a function of transmitting instructions and the like based on processing of various applications to the real-time processing unit 20. The real-time processing unit 20 has a function of transmitting information and the like collected from the ECU and the like, to the application processing unit 30 via the CAN FD. As a result, the real-time processing unit 20 and the application processing unit 30 cooperation with each other to implement various functions.

Software of the vehicle control system 2 is built in line with AUTOSAR. The AUTOSAR is an abbreviation for Automotive Open System Architecture. The AUTOSAR is a registered trademark. The AUTOSAR provides not only communication between software components (hereinafter referred to as SW-C) provided to implement various applications, but also functions related to connection to the cloud, related to security, and the like. The SW-C is parted software to implement a certain function. The application program includes one or more SW-C. Note that the software of the vehicle control system 2 does not necessarily need to be built in line with AUTOSAR.

Each device belonging to the vehicle control system 2, that is, the ECU 4, the ECU 5, the ECU 6, and the vehicle-outside communication device 7, includes a platform. The platform provides an environment for running SW-C written in a hardware-independent format.

The platform includes a runtime environment (hereinafter, RTE) and basic software (hereinafter, BSW). RTE is an interface for connecting between SW-Cs and between SW-C and BSW. BSW is a hierarchy level connecting between hardware and SW-C, and includes OS, driver, middleware, etc. Functions of the BSW are divided into small modules and the function of each module is provided to the SW-C via API. The API is an abbreviation for Application Programming Interface.

Hereinafter, the platform included in the real-time processing unit 20 is referred to as a first platform 21 (hereinafter, first PF 21), and the platform included in the application processing unit 30 is referred to as a second platform 31 (hereinafter, second PF 31).

The real-time processing unit 20 includes a control-system function block group 22 which is a set of service applications (hereinafter, service application) operating on the first PF 21. The service application is an application that receives a request from a client, perform processing, and returns a result.

The control-system function block group 22 is a group of applications that include APIs for accepting instructions related to movement of the vehicle, for supervising the instructions accepted by the APIs to implement consistent vehicle control. The control-system function block group 22 outputs various instructions via the in-vehicle communication network 8 to the in-vehicle devices 5 to 7 in which there are entities that execute control based on the instructions.

The first PF 21 includes a conversion gateway 211. The conversion gateway 211 has a function of converting a communication frame received by the real-time processing unit 20 via the CAN FD into an Ethernet format to provide the frame to the application processing unit 30. In addition, the conversion gateway 211 has a function of converting the communication frame in the Ethernet format provided by the application processing unit 30 into a CAN format.

The application processing unit 30 includes a hypervisor 32 and executes software on a plurality of virtual machines. The hypervisor 32 may be omitted.

The application processing unit 30 includes a service-system function block group 33 which is a set of service applications operating on the second PF 31.

The service-system function block group 33 is a set of service applications. Each service application includes one or more SW-Cs. The service applications are provided by third parties as well as the vehicle manufacturer manufacturing the vehicle. Examples of the third party that provides the service application include a data utilization company that provides a service via collecting data from vehicles.

The second PF 31 includes a control-system function block group 35, a data-system function block group 36, and an API gateway 40.

The control-system function block group 35 is a set of programs including APIs for accepting requests related to the vehicle control from the service-system function block group 33. The control-system function block group 35 includes an API group 37 being a plurality of APIs and converts an API access request expressed in a vehicle-independent format from the service-system function block group 33 into an API access request expressed in a vehicle-dependent format to provide the request to the real-time processing unit 20. The “vehicle-independent format” is a format common to vehicles (i.e., a format that absorbs differences among vehicle types). The “vehicle-dependent format”is a format unique to a vehicle.

The APIs in the control-system function block group 35 include kinematic APIs for vehicle movement control and other non-kinematic APIs. The API access request accepted by the kinematic API is forwarded to the control-system function block group 35, and is forwarded from the control-system function block group 35 via the in-vehicle communication network 8 to the in-vehicle device 5 to 7 that executes control based on the request. The API access request accepted by the non-kinematic API is forwarded via the in-vehicle communication network 8 to the in-vehicle device 5 to 7 that execute control based on the request.

The data-system function block group 36 is a set of programs including APIs for handling vehicle data acquired via the real-time processing unit 20 and accumulated. The data-system function block group 36 has a function of abstracting vehicle data in a vehicle-independent format from vehicle data expressed in a vehicle-dependent format supplied from the real-time processing unit 20 to accumulate the vehicle data. The data-system function block group 36 may have an API that provides a function of transmitting designated vehicle data to the ECU or the like via the Ethernet. In particular, when the destination is the vehicle-outside communication device 7, the vehicle-outside communication device 7 may upload the transmitted vehicle data to the cloud.

It should be noted that communication with the in-vehicle device 5 to 7 via the control-system function block group 35 is not limited to CAN FD, but may be Ethernet or other communication means Communication with the in-vehicle device 5 to 7 via the data-system function block group 36 may be performed not only by Ethernet, but also by CAN FD or other communication means.

The API gateway 40 is configured by utilizing a function of a virtual function bus (hereinafter referred to as VFB). VFB is middleware that enables communication between SW-Cs and between a SW-C and a BSW without consideration of hardware and communication protocols, etc., and is also called a software bus. Communication between SW-Cs is access from a SW-C to an API provided by another SW-C, and communication between a SW-C and a BSW is access from a SW-C to an API provided by the control-system function block group 35 and the data-system function block group 36.

Specifically, the SW-Cs access various APIs via the API gateway 40 and use the functions provided by the accessed APIs to implement desired functions.

For using an API, the SW-C transmits an API access request The API access request includes at least the application ID of the service application including the SW-C that is the request source and the API-ID being information indicating the API that is the request destination.

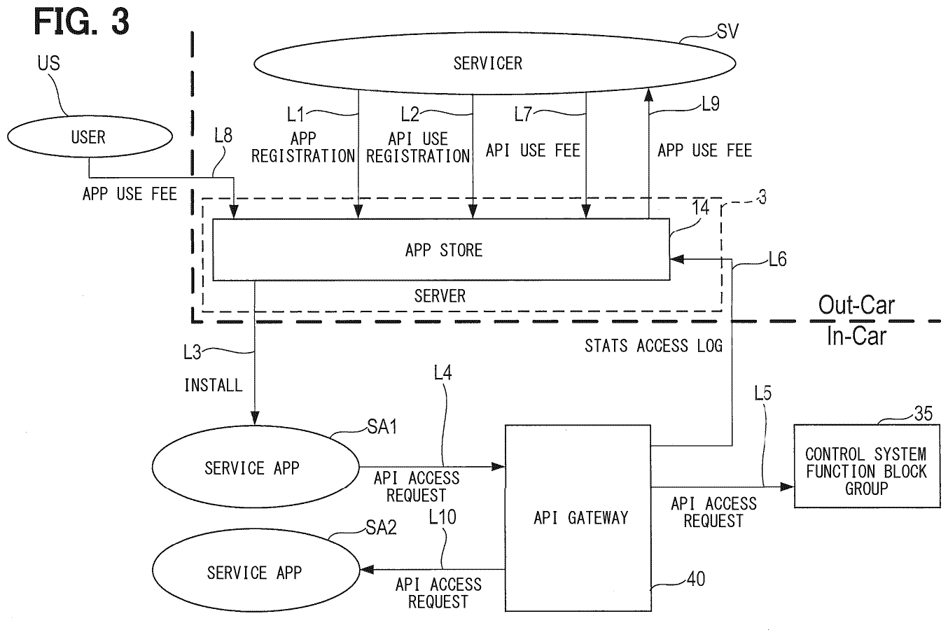

As illustrated in FIG. 3, an application store 14 is installed in the server 3. The application store 14 has a function of registering a first service application SA1, produced by the servicer SV, in the application store 14 based on an application by the servicer SV accessing the application store 14 by using the servicer terminal device 9, as indicated by the arrow L1. The first service application SA1 registered in the application store 14 is published on a website of the application store 14.

The application store 14 also has a function of registering the API used by the first service application SA1 in the application store 14 based on the application by the servicer SV, as indicated by the arrow L2.

When the user US accesses the website of the application store 14 and purchases the first service application SA1, the first service application SA1 is installed in the ECU 4 mounted on the vehicle of the user US, as indicated by the arrow L3.

When the first service application SA1 transmits an API access request to the API gateway 40 as indicated by the arrow L4, the API gateway 40 forwards the API access request to the control-system function block group 35, as indicated by the arrow L5. The control-system function block group 35 converts the API access requests into the API access requests expressed in the vehicle-dependent format to provide to the real-time processing unit 20, as described above.

The API Gateway 40 transmits a statistics access log, including the number of API uses taking into account the execution accomplishment state of API access requests and a communication data amount associated with the API uses, to application store 14, as indicated by the arrow L6.

Based on the statistics access log received from the API Gateway 40, the application store 14 calculates the API use fee due to the use of the API by the service application SA1 and charges the servicer SV the API use fee. The servicer SV pays the API use fee to the application store 14, as indicated by the arrow L7.

The application store 14 calculates the application use fee for the first service application SA1 based on the usage of the first service application SA1 and charges the user US the application use fee. The user US pays the billed application use fee to the application store 14, as indicated by the arrow L8. The application store 14 transfers the application use fee paid by the user US to the servicer SV, as indicated by the arrow L9.

As indicated by the arrow L10, when the first service application SA1 transmits an API access request to the API gateway 40, the API gateway 40 may forward the API access request to the second service application SA2, which provides a different service than the first service application SA1.

A procedure when a servicer SV makes an API use agreement will be described next.

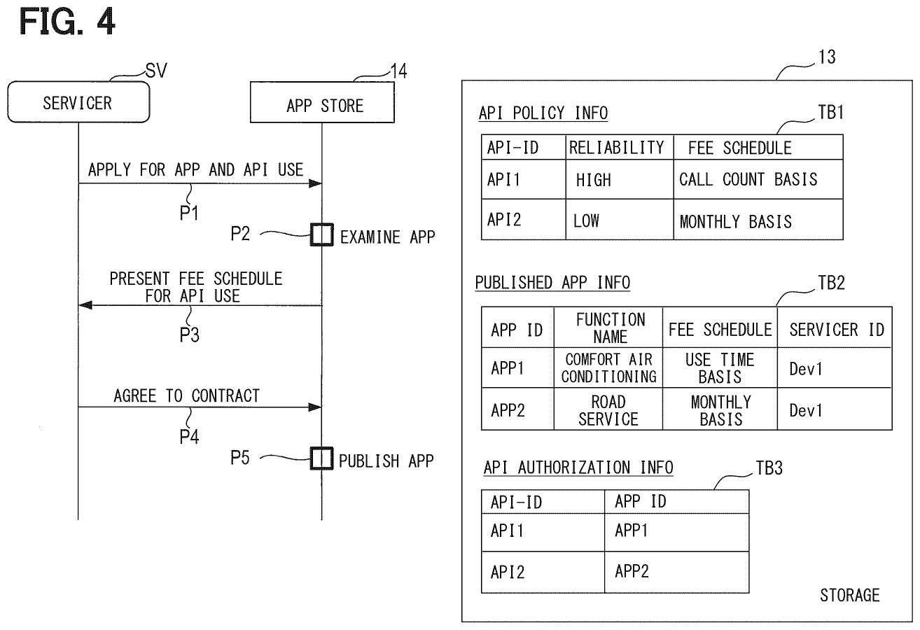

As indicated by a process P1 in FIG. 4, the servicer SV accesses the application store 14 and applies for registration of the service application to be published and registration of the API to be used.

As indicated by a process P2, the application store 14 examines whether the control-system function block group 35 is accessible to the service application applied for by the service provider SV.

When the control-system function block group 35 is accessible to the service application applied for, the application store 14 presents a use API fee schedule to the servicer SV, as indicated by a process P3.

For each API applied for, the application store 14 stores API policy information including API-ID, reliability, and fee schedule in the storage 13, as illustrated in the table TB1.

In the table TB1, the API with API-ID of API1 is such that the reliability is “high” and the fee schedule is “call count-basis”, the API with the API-ID of API2 is such that the reliability is “low”and the fee schedule is “monthly-basis”.

An API to which the high reliability is set accepts API access requests that are from service applications with high reliability and rejects API access requests that are from service applications with low reliability.

An API to which the low reliability is set accepts API access requests even from service applications with low reliability.

The “call-count basis” refers to a charging form where a fee is added according to the number of times the API access request occurs. The “monthly basis” refers to a charging form where a flat fee independent of the number of times the API access request occurs is charged every month.

The servicer SV notifies the application store 14 of an agreement to the contract including the presented use API fee schedule, as indicated by a process P4. As a result, the application store 14 publishes the service application applied for by the service provider SV on the website of the application store 14, as indicated by a process P5.

The application store 14 stores, in the storage 13, information on the service application published on the website (hereinafter, published application information) and information on the API authorized for the service application published on the website (hereinafter, API authorization information).

For each service application published, the published application information includes the application ID, the function name of the service application, the fee schedule of the service application, and the servicer ID, as illustrated in a table TB2. The application ID is information for identifying the service application. The service provider ID is information for identifying the provider of the service application.

In the table TB2, the service application with the application ID of APP1 is such that the function name is “Comfort Air Conditioning and the fee schedule is “use time basis” , and the servicer ID is “Dev1”. The service application with the application ID of APP2 is such that the function name is “Road Service”, the fee schedule is “Monthly basis”, and the servicer ID is “Dev1”.

The “use time basis” fee schedule is a charging form where a fee is added according to the use time of the service application. The “monthly basis” fee schedule is a charging form where a flat fee independent of the use time of the service application is charged every month.

For each API use of which is authorized, the API authorization information includes an API-ID and an application ID, as illustrated in the table TB3.

The table TB3 illustrates that an API with the API-ID of API1 is called by a service application with the application ID of APP1, and an API with the API-ID of API2 is called by a service application with the application ID of APP2 API.

Next, description will be given of how a charging related factor causes use of the API to be suspended.

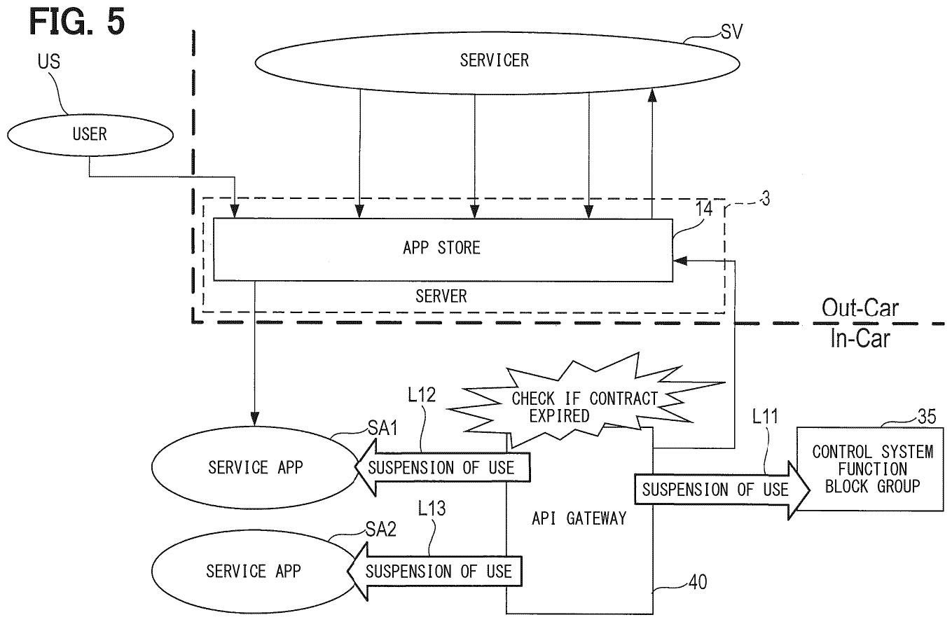

As illustrated in FIG. 5, the API Gateway 40 determines whether or not the contract for API use has expired. When it is determined that the contract for API use has expired, the API Gateway 40 transmits a first API use suspension request, which indicates that the expired API use is to be suspended, to the control-system function block group 35, the first service application SA1, and the second service application SA2, as indicated by arrows L11, L12, and L13. The first API use suspension request is provided with the API-ID for identifying the API of which use is requested to be suspended.

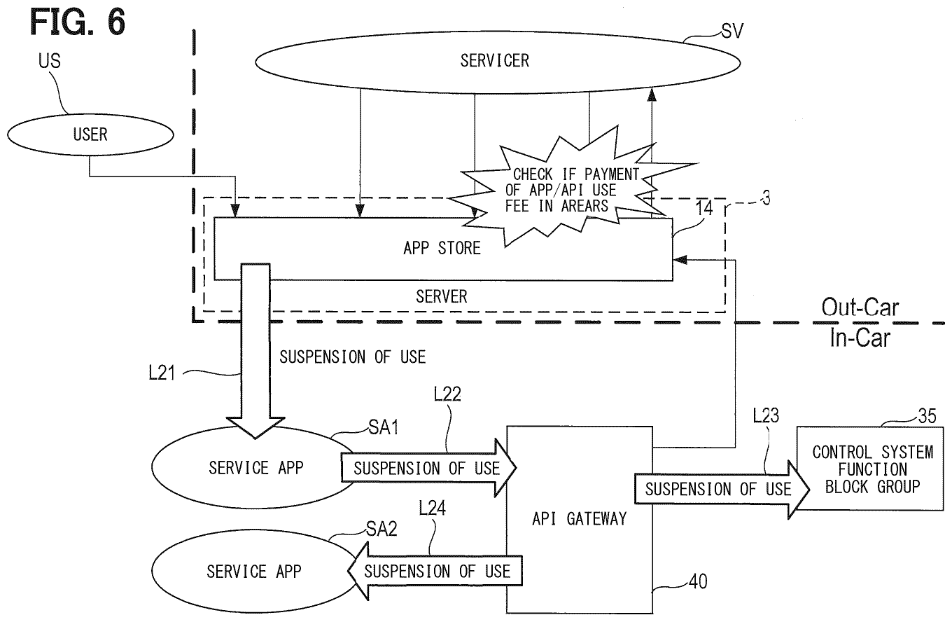

As illustrated in FIG. 6, the application store 14 determines whether or not the payment by the user US of the use fee for the first service application SA1 is in arrears and whether or not the payment by the servicer SV for of the use fee for the API is in arrears. Then, when it is determined that the user US is in arrears on the payment of the use fee for the first service application SA1, or when it is determined that the servicer SV is in arrears on the payment of the API use fee, the application store 14 transmits a second API use suspension request to the first service application SA1, as indicated by the arrow L21, wherein the second API use suspension request indicates that use of the API is to be suspended due to the arrears. The second API suspension request is provided with the API-ID for identifying the API of which use is requested to be suspended.

Upon receiving the second API use suspension request, the first service application SA1 transmits the second API use suspension request to the API gateway 40, as indicated by the arrow L22.

Upon receiving the second API use suspension request, the API gateway 40 transmits the second API use suspension request to the control-system function block group 35 and the second service application SA2, as indicated by the arrows L23 and L24.

The API gateway 40 also determines whether or not the fee for use of the first service application SA1 by the user US exceeds a charge upper limit set by the user US. In addition, the API Gateway 40 determines whether or not the fee for the API use by the first service application SA1 exceeds a charge upper limit set by the servicer SV.

Then, when it is determined that the use fee for the first service application SA1 exceeds the charge upper limit, or when it is determined that the API use fee exceeds the charge upper limit, the API gateway 40 transmits a third API use suspension request to the control-system function block group 35, the first service application SA1 and the second service application SA2, wherein the third API use suspension request indicates that use of the API is to be suspended because the charge upper limit is exceeded. The third API suspension request is provided with the API-ID for identifying the API of which use is requested to be suspended.

The API Gateway 40 also determines whether or not a resource to perform the processing corresponding to the API is insufficient. Upon determining that the resource to perform the processing corresponding to the API is insufficient, the API gateway 40 transmits a fourth API use suspension request to the control-system function block group 35, the first service application SA1 and the second service application SA2, wherein the fourth API use suspension request indicates that the use of the API with the insufficient resource is to be suspended. The fourth API suspension request is provided with the API-ID for identifying the API of which use is requested to be suspended.

Next, a procedure of the API use control process performed by API Gateway 40 will be described. The API use control process is repeatedly executed during the operation of the ECU 4.

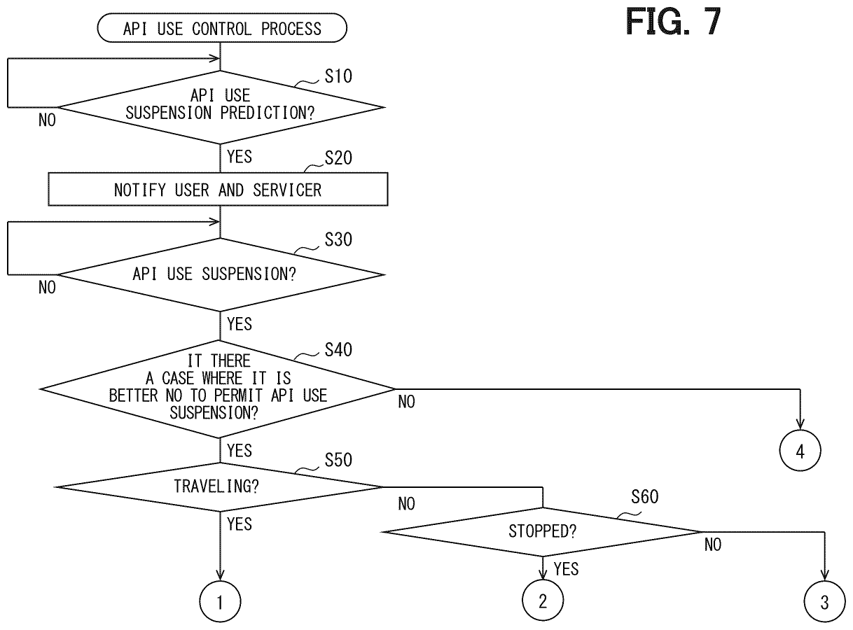

When the API use control process is executed, the API gateway 40 (hereinafter referred to as APIGW 40) determines in S10 whether or not an API use suspension prediction is present, as illustrated in FIG. 7.

Specifically, upon receiving API use suspension prediction information from the application store 14, the APIGW 40 determines that the API use suspension prediction is present. The API suspension prediction information includes a list of service applications that become unavailable due to suspending use of the API, the reason for suspending use of the API, the timing to suspend use of the API (e.g., “suspend the API in X minutes”), notes regarding suspending use of the API, and the additional fee charged.

The APIGW 40 determines that the API use suspension prediction is present, also in such cases as when the API use contract has expired, when the service application use fee exceeds the charge upper limit, when the API use fee exceeds the charge upper limit, and when the resource to perform the processing corresponding to the API is insufficient. The APIGW 40 transmits the first, third, and fourth API use suspension requests described above after a preset waiting time has elapsed since the APIGW 40 determined the presence of the API use suspension prediction.

Here, in the absence of the API use suspension prediction, the APIGW 40 repeats the process in S10 to wait for the API use suspension prediction. When there is the API use suspension prediction, the APIGW 40 notifies the user US and the servicer SV that the service application is to be suspended, in S20. In addition to the suspension of the service application, the APIGW 40 notifies the user US and servicer SV of the list of service applications that become unavailable due to suspending use of the API, the reason for suspending use of the API, the timing to suspend use of the API, the notes regarding suspending use of the API, and the additional fee charged.

Specifically, when the occupant is present in the vehicle, the APIGW 40 notifies the user US that the service application is to be suspended, for example, by displaying on the display screen of the navigation device 100. The APIGW 40 determines whether or not an occupant is present in the vehicle by detecting, for each of a plurality of seats in the vehicle cabin, whether or not an occupant is seated based on the detection results of a plurality of seating sensors installed to the plurality of seats in the vehicle cabin.

When no occupant is present in the vehicle, the APIGW 40 notifies the portable terminal device 10 of the user US that the service application is to be suspended. The phone number or e-mail address of the portable terminal device 10 of the user US is pre-registered in the ECU 4.

The APIGW 40 notifies the servicer terminal device 9 of the servicer SV that the service application is to be suspended.

In S30, the APIGW 40 determines whether or not it is timing to suspend use of the API. Specifically, upon receipt of the above second API use suspension request from the application store 14, the APIGW 40 determines that it is timing to suspend use of the AP. Also, upon the timing to transmit the first, third, fourth API use suspension request described above, the APIGW 40 determines that it is timing to suspend use of the API.

Here, when it is not the timing to suspend use of the API use, the APIGW 40 repeats the S30 process to wait for the API use suspending timing. When it is timing to suspend the API use, the APIGW 40 determines in S40 whether or not, with respect to the API of which use is requested to be suspended (hereinafter referred to as “suspension target API”), there is a case where it is better not to permit to suspend use of the API. Specifically, the APIGW 40 refers to a no-permission setting table to determines whether or not, with respect to the suspension target API, there is a case in which it is be better not to permit to suspend use of the API, wherein in the no-permission setting table, API no-permission information indicative of whether no-permission possibility is present or absent is preset for each AP. The no-permission setting table is stored in the flash ROM 4d.

APIs that are not involved in cases where it is better not to permit to suspend use of the API include, for example, information-collection API, an API for improvement of the cabin space of the vehicle, and an entertainment API.

For example, APIs that are involved in cases where it is better not to permit to permit to suspend use of the API include an API directly related to a driving operation, an automatic driving system API, and an advanced driver assistance system API.

When, with respect to the suspension target API, there is no case in which it is be better not to permit to suspend the API use, the APIGW 40 proceeds to S120. On the other hand, when there is a case in which it is be better not to permit to suspend the API use, the APIGW 40 determines in S50 whether or not the vehicle is in motion. Specifically, the APIGW 40 determines that the vehicle is in motion when the vehicle's travel speed is greater than or equal to a preset travel determination speed (e.g., 3 km/h).

When the vehicle is in motion, the APIGW 40 proceeds to S70. On the other hand, when the vehicle is not in motion, the APIGW 40 determines in S60 whether the vehicle is stopped. Specifically, APIGW 40 determines that the vehicle is stopped when the vehicle speed is less than a preset stop determination speed (e.g., 3 km/h) and the shift position is in drive or neutral.

When the vehicle is stopped, the APIGW 40 proceeds to S90. On the other hand, when the vehicle is not stopped, the APIGW 40 determines that the vehicle is parked, and proceeds to S110.

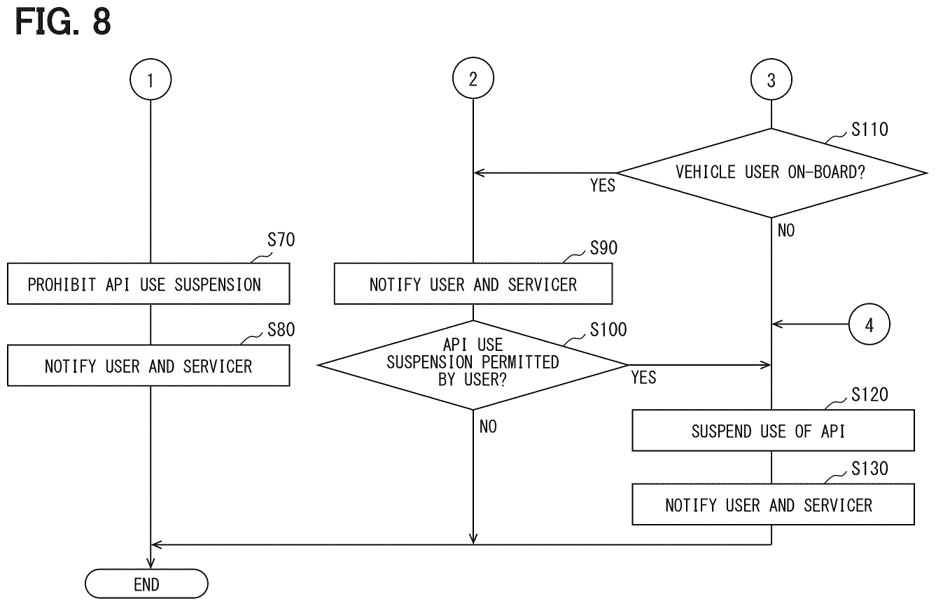

Upon proceeding to S70, as illustrated in FIG. 8, the APIGW 40 prohibits suspending use of the suspension target API. This will result in additional fee for continued API use. The additional fee for continued API use will be calculated separately from regular charges. The additional fee may be covered by the user US or by the servicer SV. For example, the user may cover the excess fee for which the user US is responsible, and the servicer may cover the excess fee that are unavoidable with respect to safety consideration.

In S80, the APIGW 40 notifies the user US and the servicer SV that suspending use of the suspension target API is prohibited, and ends the API use control process. Specifically, the APIGW 40 notifies the user US that suspending use of the suspension target API is prohibited by, for example, displaying on the display screen of the navigation device 100 when the occupant is present in the vehicle. When the occupant is not present in the vehicle, the APIGW 40 notifies the portable terminal device 10 of the user US that suspending use of the suspension target API is prohibited. The APIGW 40 notifies the servicer terminal device 9 of the servicer SV that suspending use of the suspension target API is prohibited.

Upon proceeding to S90, the APIGW 40 notifies the user US and the servicer SV that the service application is to be suspended, as is the case of S20.

In S100, the APIGW 40 determines whether or not the user US has permitted to suspend use of the API, based on the input operation by the user US via the above input device mounted on the vehicle. Specifically, if the user input information, which is output by the input device according to the input operation by the user US via the input device described above, indicates a permission to suspend use of the API, the APIGW 40 determines that the user US has permitted to suspend use of the API. When the user input information indicates a refusal to suspend use of the API, the APIGW 40 determines that the user US has not permitted to suspend use of the API. When the input device has not output user input information within the preset waiting time, the APIGW 40 determines that the user US has not permitted to suspend use of the API use.

When the permission to suspend use of the API is not given by the user US, the APIGW 40 ends the API use control process. This will result in an additional fee for continued API use. The additional fee for continued API use will be calculated separately from regular charges.

Upon proceeding to S110, the APIGW 40 determines whether or not the vehicle user is in the vehicle. Specifically, the APIGW 40 determines that the vehicle user is on board when one or more seats are occupied by one or occupants based on the detection results of multiple seating sensors.

When the vehicle user is in the vehicle, the APIGW 40 proceeding to S90. On the other hand, when the vehicle user is not in the vehicle, the APIGW 40 suspends use of the suspension target API in S120.

In S130, the APIGW 40 notifies the user US and the servicer SV of spending the service application in the same manner as in S20, and ends the API use control process.

The ECU 4 configured as described above is mounted on the vehicle, connected to the plurality of in-vehicle devices 5 to 7 by the in-vehicle communication network 8, and constitutes the vehicle control system 2 together with the plurality of in-vehicle devices 5 to 7.

The ECU 4 includes the API gateway 40. The API gateway 40 is configured to provide cooperation between the first service application SA1 configured to provide the service to the vehicle and the control-system function block group 35 configured to control the vehicle. The control-system function block group 35 includes the API group 37. The API group 37 is configured to convert the API access request expressed in the vehicle-independent format and transmitted from the first service application SA1 into the vehicle-dependent format. The API gateway 40 is configured to forward the API access request, transmitted from the first service application SA1, to the control-system function block group 35.

The API gateway 40 is configured to determine whether or not a use suspension condition, which is preset and indicates that use of the API group 37 is required to be suspended by a factor related to charging for use of at least one of the first service application SA1 or the API group 37, is satisfied.

The API gateway 40 is configured to switch over the operation of the vehicle control system 2 based on: the API no-permission information of the API satisfying the use suspension condition; the vehicle state information indicating the vehicle state; and the user input information entered by the user US who uses the vehicle. Although the control-system function block group 35 and the data-system function block group 36 are equipped with APIs, the switch over of the operation of the vehicle control system 2 based on the API no-permission information and the like is applied to the control-system function block group 35 and not to the data-system function block group 36.

The ECU 4 switches over the operation of the vehicle control system 2 based on the API no-permission information, the vehicle state information, and the user input information. Because of this, the ECU 4 can suppress occurrence of a situation in which the use of the API is uniformly suspended when use of the API is required to be suspended by a factor related to charging and the user US becomes unable to use the service, improving the convenience of the user US who uses the service.

The vehicle state information includes the traveling state information indicating the traveling state of the vehicle and the occupant presence absence information indicating whether the vehicle occupant is present or absent. The API gateway 40 is configured to switch over the operation of the vehicle control system 2 by determining whether to prohibit or permit to suspend use of the API based on the API no-permission information, the vehicle state information, and the user input information. Because of this, the ECU 4 can determine whether to prohibit or permit to suspend use of the API based at least on whether or not the vehicle is in motion and whether or not the occupant is present in the vehicle.

The API gateway 40 is configured to prohibit suspending use of the API, upon: determining, based on the API no-permission information, that there is a possibility that it is better not to permit to suspend use of the API; and determining, based on the traveling state information, that the vehicle is in motion. Because of this, the ECU 4 can suppress occurrence of a situation in which a necessary service cannot be used while the vehicle is in motion, further improving the convenience of the user US who uses the service.

The API gateway 40 is configured to permit to suspend use of the API upon: determining, based on the API no-permission information, that the there is a possibility that it is better not to permit to suspend use of the API; determining, based on the traveling state information, that the vehicle is stopped; and determining, based on the user input information, that the user US has permitted to suspend use of the API. Because of this, the ECU 4 can suspend the use of the API when the vehicle is stopped and the user US has permitted to suspend use of the API. In other words, the use of the API is suspended when the user US determines that the use of the API is not necessary. Therefore, even when the use of the API is suspended, the ECU 4 can suppress occurrence of a situation in which the service necessary for the user US becomes unavailable, further improving the convenience of the user US who uses the service.

The API gateway 40 is configured to permit to suspend use of the function API upon: determining, based on the API no-permission information, that there is a possibility that it is better not to permit to suspend use of the API; determining, based on the traveling state information, that the vehicle is parked: determining, based on the occupant presence information, that the occupant is present in the vehicle; and determining, based on the user input information, that the user US has permitted to suspend use of the API. Because of this, the ECU 4 can suspend the use of the API when the user US has permitted to suspend use of the API while the vehicle is parked. In other words, the use of the API is suspended when the user US determines that the use of the API is not necessary. Therefore, even when the use of the API is suspended, the ECU 4 can suppress an occurrence of a situation in which a service necessary for the user US becomes unavailable, further improving the convenience of the user US who uses the service.

The API gateway 40 is configured to permit to suspend use of the function API upon: determining, based on the API no-permission information, that there is a possibility that it is better not to permit to suspend use of the API; determining, based on the traveling state information, that the vehicle is parked; and determining, based on the occupant presence information, that no occupant is present in the vehicle. Because of this, the ECU 4 can suspend the use of the API when the vehicle is parked and no occupant is present in the vehicle. In other words, the use of the API is suspended when the user US who uses the service is not present in the vehicle. Therefore, even when the use of the API is suspended, the ECU 4 can suppress occurrence of a situation in which a service necessary for the user US becomes unavailable, further improving the convenience of the user US who uses the service.

The API Gateway 40 is configured to permit to suspend use of the API upon determining, based on the API no-permission information, that there is no possibility that it is better not to permit to suspend use of the API. In other words, an API of which suspending use poses no problem for the user US is uniformly suspended according to the factor related to charging. In this way, since the ECU 4 suspends use of the API of which suspending use poses no problem for the user US, it is possible to suppress the occurrence of a situation in which a service necessary for the user becomes unavailable to the user US even when the use of the API is suspended, further improving the convenience of the user US who uses the service.

The API gateway 40 is also configured to determine whether or not a use suspension prediction condition, which is preset and indicates that there is a possibility of suspending use of the API, is satisfied. The API gateway 40 is configured to notify the user US that the first service application SA1 that uses this API is to be suspended, upon determining that use suspension prediction condition is satisfied. Because of this, the ECU 4 causes the user US to be aware of a possibility that the first service application SA1 becomes unavailable.

The API gateway 40 is configured to notify the user US by using the navigation device 100 installed in the vehicle when the occupant is present in the vehicle, and to notify the user by using the portable terminal device 10 pre-registered for the user US when the occupant is absent in the vehicle. Because of this, the ECU 4 can suppress occurrence of a situation in which the user US fails to recognize the suspension of use of the first service application SA1.

In the embodiment described above: the ECU 4 corresponds to an in-vehicle device; the ECU 5, the ECU 6, and the vehicle-outside communication device 7 correspond to a plurality of electronic control units; and the in-vehicle communication network 8 corresponds to an in-vehicle network.

The first service application SA1 corresponds to a service application, the control-system function block group 35 corresponds to a control system function block, the API gateway 40 corresponds to a cooperation controller, and the API group 37 corresponds to a function interface.

S30 corresponds to processing by a use suspension determiner, the determination condition in S30 corresponds to a use suspension condition, S40 to S70 and S100 to S120 correspond to processing by a use controller, and the API no-permission information corresponds to function interface information.

S10 corresponds to processing by a prediction determiner, the determination condition in S10 corresponds to a use suspension prediction condition, S20 corresponds to processing by a notifier, the navigation device 100 corresponds to a first notification device, and the portable terminal device 10 corresponds to a second notification device.

Although an embodiment of the present disclosure has been described above, the present disclosure is not limited to the above embodiment, and various modifications are possible.

### First Modification

The above embodiment illustrates determining whether or not there is a case where it is better not to permit to suspend use of the API, based on the API no-permission information indicating whether the no-permission possibility is present or absent. Alternatively, instead of whether the no-permission possibility is present or absent, the determination of whether or not there is a case where it is better not to permit to suspend the API use may be made based on the level (e.g., 0, 1, 2, 3, . . .) of the no-permission possibility.

### Second Modification

The above embodiment illustrates prohibiting from suspending use of the API when the vehicle is in motion. Alternatively, prohibiting from suspending use of the API may cause the continued use of the API and then cause suspending use of the API at a time when it is safe to suspend use of the AP. When the vehicle has an automatic driving function, the vehicle may automatically transition to evacuation driving to suspend use of the API.

### Third Modification

The above embodiment illustrates performing the process S110 as illustrated in FIG. 7. Alternatively, the process S110 may not be performed. Specifically, if the vehicle is not stopped in S60, the APIGW 40 may proceeds to S120. This enables the ECU 4 to suspend use of the API as soon as possible.

### Fourth Modification

The above embodiment illustrates determining whether the vehicle is in motion, stopped, or parked based on the vehicle travel speed and shift position, alternatively, the vehicle traveling state may be determined based on information from the navigation device 100.

### Fifth Modification

The above embodiment illustrates that a charging-related factor causes use of the API to be suspended. Alternatively, the API use suspension may collectively control all APIs used by safety-critical service applications.

### Sixth Modification

The above embodiment illustrates that a charging-related factor causes use of the API to be suspended. Alternatively, the API use suspension may be controlled by prohibiting startup of the service application or by forcibly terminating the service application.

The ECU 4 and the method described in the present disclosure may be implemented by a dedicated computer provided by configuring a memory a processor programmed to execute one or more functions embodied by a computer program. Alternatively, the ECU 4 and the methods described in the present disclosure may be implemented by a dedicated computer provided by configuring a processor with one or more dedicated hardware logic circuits. Alternatively, the ECU 4 and the method described in the present disclosure may be implemented by one or more dedicated computers provided by configuring a memory and a processor programmed to execute one or more functions in combination with one or more hardware logic circuits. The computer program may be stored in a computer-readable non-transitory tangible storage medium as instructions to be executed by a computer. A method for providing functions of respective parts included in the ECU 4 does not necessarily need to include software, and all of the functions may be provided using one or more hardware.

Multiple functions provided by a single element in the above-described embodiment may be provided by multiple elements, and a single function provided by a single element may be provided by multiple elements. Multiple functions provided by multiple elements may be provided by a single element, or one function provided by multiple elements may be provided by a single element. Part of the configuration of the above embodiment may be omitted. At least part of the configuration of the described above embodiment may be added to or replaced with another embodiment.

In addition to the ECU 4 described above, the present disclosure may be embodied into various forms such as a system including the ECU 4 as a component, a program for causing a computer to function as the ECU 4, a non-transitory tangible storage medium such as a semiconductor memory storing this program, and a service providing method.

What is claimed is:

1. An in-vehicle device mounted on a vehicle and connected to a plurality of electronic control units by an in-vehicle network, wherein the in-vehicle device and the plurality of electronic control units are included in a vehicle control system, the in-vehicle device comprising:
a cooperation controller, provided by a computer including a processor and a memory, configured to provide cooperation between a service application configured to provide a service to the vehicle and a control system function block configured to control the vehicle,
wherein
the control system function block includes a function interface configured to convert an access request expressed in a vehicle-independent format and transmitted from the service application into a vehicle-dependent format,
the cooperation controller is configured to forward the access request, transmitted from the service application, to the control system function block, and
the cooperation controller includes:
a use suspension determiner configured to determine whether or not a use suspension condition, which is preset and indicates that use of the function interface is required to be suspended by a factor related to charging for use of at least one of the service application or the function interface, is satisfied; and
a use controller configured to switch over operation of the vehicle control system based on: function interface information relating to the function interface for which the use suspension condition is satisfied; vehicle state information indicating a vehicle state; and user input information entered by a user who uses the vehicle.

2. The in-vehicle device according to claim 1, wherein:
the vehicle state information includes traveling state information indicating a traveling state of the vehicle and occupant presence absence information indicating whether an occupant is present or absent in the vehicle; and
the use controller is configured to switch over the operation of the vehicle control system by determining whether to prohibit or permit to suspend use of the function interface based on the function interface information, the vehicle state information, and the user input information.

3. The in-vehicle device according to claim 2, wherein
the use controller is configured to prohibit suspending use of the function interface upon: determining, based on the function interface information, that there is a possibility that it is better not to permit to suspend use of the function interface; and determining, based on the traveling state information, that the vehicle is in motion.

4. The in-vehicle device according to claim 2, wherein
the use controller is configured to permit to suspend use of the function interface upon: determining, based on the function interface information, that there is a possibility that it is better not to permit to suspend use of the function interface;
determining, based on the vehicle state information, that the vehicle is traveling; and
determining, based on the user input information, that the user has permitted to suspend use of the function interface.

5. The in-vehicle device according to claim 2, wherein
the use controller is configured to permit to suspend use of the function interface upon: determining, based on the function interface information, that there is a possibility that it is better not to permit to suspend use of the function interface; determining, based on the vehicle state information, that the vehicle is parked; determining based on the occupant presence absence information that the occupant is present in the vehicle; and determining, based on the user input information, that the user has permitted to suspend use of the function interface.

6. The in-vehicle device according to claim 2, wherein
the use controller is configured to permit to suspend use of the function interface upon: determining, based on the function interface information, that there is a possibility that it is better not to permit to suspend use of the function interface; determining, based on the vehicle state information, that the vehicle is parked; and determining based on the occupant presence absence information that the occupant is absent in the vehicle.

7. The in-vehicle device according to claim 2, wherein
the use controller is configured to permit to suspend use of the function interface upon determining based on the function interface information that there is no possibility that it is better not to permit to suspend use of the function interface.

8. The in-vehicle device according to claim 2, wherein
the cooperation controller further includes:
a prediction determiner configured to determine whether or not a use suspension prediction condition, which is preset and indicates that there is a possibility of suspending use of the function interface, is satisfied; and
a notifier configured to notify the user that use of the service application using the function interface is to be suspended, upon determining that the use suspension prediction condition is satisfied.

9. The in-vehicle device according to claim 8, wherein
the notifier is configured to notify the user by using a first notification device installed in the vehicle when the occupant is present in the vehicle, and notify the user by using a second notification device pre-registered for the user when the occupant is not present in the vehicle.

10. A service providing method performed by an in-vehicle device mounted on a vehicle and connected to a plurality of electronic control units by an in-vehicle network, wherein the in-vehicle device and the plurality of electronic control units are included in a vehicle control system,
the in-vehicle device includes a cooperation controller configured to provide cooperation between a service application configured to provide a service to the vehicle and a control system function block configured to control the vehicle,
the control system function block includes
a function interface configured to convert an access request expressed in a vehicle-independent format and transmitted from the service application into a vehicle-dependent format, and
the cooperation controller is configured to forward the access request, transmitted from the service application, to the control system function block,
the service providing method comprising:
at the cooperation controller, determining whether or not a use suspension condition, which is preset and indicates that use of the function interface is required to be suspended by a factor related to charging for use of at least one of the service application or the function interface, is satisfied; and
at the cooperation controller, switching over operation of the vehicle control system based on: function interface information relating to the function interface for which the use suspension condition is satisfied; vehicle state information indicating a vehicle state; and user input information entered by a user who uses the vehicle.

11. A service providing program stored on a non-transitory storage medium for a computer of an in-vehicle device mounted on a vehicle and connected to a plurality of electronic control units by an in-vehicle network, wherein the in-vehicle device and the plurality of electronic control units are included in a vehicle control system, and
the service providing program causes the computer of the in-vehicle device to function as:
a function interface configured to convert an access request expressed in a vehicle-independent format and transmitted from a service application into a vehicle-dependent format, wherein the service application is configured to provide a service to the vehicle;
a cooperation controller configured to:
provide cooperation between the service application and a control system function block including the function interface and configured to control the vehicle; and
forward the access request, transmitted from the service application, to the control system function block;
a use suspension determiner configured to determine whether or not a use suspension condition, which is preset and indicates that use of the function interface is required to be suspended by a factor related to charging for use of at least one of the service application or the function interface, is satisfied; and
a use controller configured to switch over operation of the vehicle control system based on: function interface information relating to the function interface for which the use suspension condition is satisfied; vehicle state information indicating a vehicle state; and user input information entered by a user who uses the vehicle.
